(19) United States
(12) Patent Application Publication
(10) Pub. No.: US 2012/0056812 A1
(43) Pub. Date: Mar. 8, 2012

(54) MOUSE HAVING ADJUSTABLE WEIGHT CARTRIDGE AT ITS CENTER OF GRAVITY

(75) Inventor: Wei-Shun CHAN, Sinjhuang City (TW)

(73) Assignee: KEY MOUSE ELECTRONIC ENTER

(21) Appl. No.: 12/877,185

(22) Filed: Sep. 8, 2010

(51) Int. Cl. G06F 3/033

(52) U.S. Cl. 345/163

(57) ABSTRACT

A mouse having an adjustable weight cartridge at its center of gravity is configured to generate a desired total weight by using at least one counterweight and includes a casing and a weight cartridge. The casing is gripped by a user and located in the center of palm of the user. The casing is provided with a receiving trough. The weight cartridge is removably disposed in the receiving trough. The at least one counterweight is disposed in the weight cartridge in a stack. The user can freely adjust the total weight of the mouse by increasing or decreasing the number of the counterweights.

### BACKGROUND OF THE INVENTION

1. Field of the Invention

The present invention relates to an input device for a computer, and in particular to a mouse having an adjustable weight cartridge at its center of gravity.

2. Description of Prior Art

Since modern computers are more and more convenient in people's daily life, the computers are not merely used in calculation and document management. For example, the computers may be further used in playing video games or online games. Thus, peripheral devices for the computer, such as a mouse or keyboard, have to be improved or re-designed in order to conform to the needs of game players.

The traditional mouse is mainly used for moving a cursor and tapping a left or right key of the mouse to select a desired icon on the screen of the computer. Thus, the moving sensitivity of the cursor is the most important property of the mouse. In order to get higher scores in playing video games or online games, many game players request higher moving sensitivity of the cursor. Although using a trackball or optical sensor can improve the moving sensitivity of the cursor, the level of sensitivity may also depend on the operating feeling of a game player. Since different game players have different operating feelings, various mice having an adjustable weight cartridge are available in the market to conform to the requirements of different customers.

Taiwan Patent No.I287737 discloses a computer peripheral device having an adjustable weight, in which a magnetic body is provided on the bottom surface of the mouse. A plurality of magnetic counterweights is attracted onto the magnetic body, thereby adjusting the total weight of the mouse. However, the bottom surface of the mouse is directly brought into contact with a table or desk surface, so that the magnetic counterweights may fall off the magnetic body easily when the bottom surface of the mouse moves on the table or desk surface. Further, Taiwan Patent No.I291644 discloses a mouse having an adjustable weight, in which batteries of different weight and dimensions are disposed to adjust the total weight of the mouse. However, such a weight adjustment is limited by the number and dimensions of the batteries. The user cannot adjust the weight of the mouse to his most favorite weight. On the other hand, a common wired mouse needs not batteries, so that the above solution of adjusting the total weight of the mouse by adding or decreasing batteries is only suitable for a wireless mouse. However, some wireless mice are provided with a rechargeable battery, so that it is unable to change the dimension and number of the batteries to adjust the total weight in such a wireless mouse.

In order to solve the problems in the aforesaid two patent documents, Taiwan Patent No.M303433 discloses a mouse having an adjustable weight, in which a weight receiving trough is provided on the bottom of the mouse and a plurality of counterweights is disposed in the weight receiving trough. Such a solution can prevent the counterweights from falling off the mouse and the weight adjustment of the mouse is not restricted by the number and dimension of the batteries. However, the counterweights are distributed on the same horizontal plane, so that the effect of weight concentration is not significant. Even, the center of gravity may be unbalanced when the user takes some counterweights out of the mouse, which negatively affects the operation of the mouse.

In view of the above, the present Inventor proposes a novel and reasonable structure based on his researches and expert knowledge.

### SUMMARY OF THE INVENTION

The present invention is to provide a mouse having an adjustable weight cartridge at its center of gravity, in which a weight cartridge is provided at the center of gravity of the mouse for accommodating a plurality of counterweights in a vertical or transverse stack. With this arrangement, the counterweights are kept in the same center of gravity without changing the operating feeling of a user when he/she changes the number of the counterweights. Further, the user can freely adjust the total weight of the mouse by increasing or decreasing the number of the counterweights.

The present invention is to provide a mouse having an adjustable weight cartridge at its center of gravity. The counterweights are disposed in the mouse at a position gripped by the user and located in the center of palm of the user. Since the counterweights are received in the weight cartridge and then the combination of the weight cartridge and the counterweights are disposed in the mouse, the external appearance of the mouse will not be affected. The counterweights can be designed to have the same size without changing the profile of the mouse. Further, it is convenient for the user to remove the weight cartridge from the mouse for adjusting the total weight of the mouse.

The present invention provides a mouse having an adjustable weight cartridge at its center of gravity, configured to generate a desired total weight by using at least one counterweight and including: a casing and a weight cartridge, wherein the casing is gripped by a user and located in the center of palm of the user, the interior of the casing is provided with a receiving trough, the weight cartridge is removably disposed in the receiving trough, the at least one counterweight is disposed in the weight cartridge in a stack.

The present invention provides a mouse having an adjustable weight cartridge at its center of gravity, including a casing, a weight cartridge and at least one counterweight, wherein the casing is gripped by a user and located in the center of palm of the user, the interior of the casing is provided with a receiving trough, the weight cartridge is removably disposed in the receiving trough of the casing, the at least one counterweight is disposed in the weight cartridge in a stack.

### BRIEF DESCRIPTION OF DRAWING

FIG. 1 is an exploded perspective view showing the structure of a first embodiment of the present invention;

FIG. 2 is an exploded perspective view showing the first embodiment of the present invention, in which a weight cartridge is removed from the mouse;

FIG. 3 is an assembled perspective view showing the first embodiment of the present invention, in which the weight cartridge is disposed in the mouse;

FIG. 4 is a cross-sectional view showing the first embodiment of the present invention;

FIG. 5 is an exploded perspective view showing a second embodiment of the present invention, in which the weight cartridge is disposed in the mouse at another position; and

FIG. 6 is an assembled perspective view showing the second embodiment of the present invention, in which the weight cartridge is disposed in the mouse at another position.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

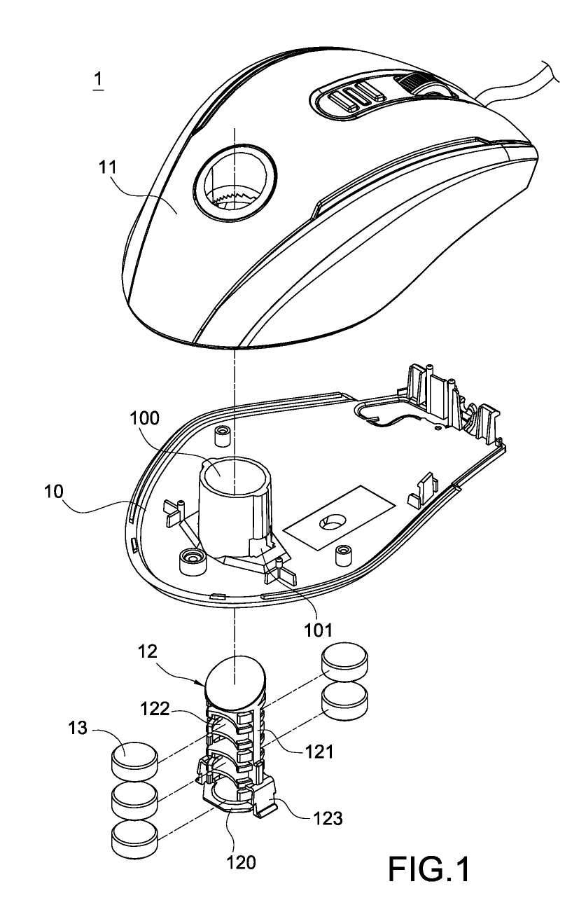

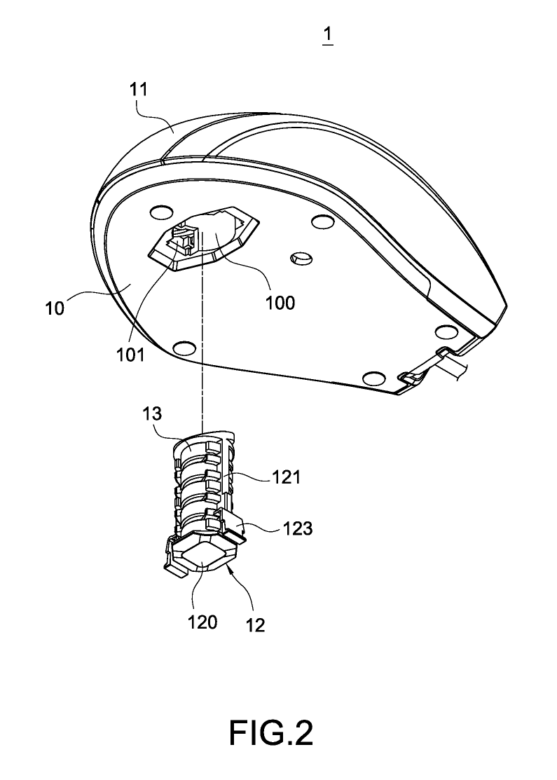

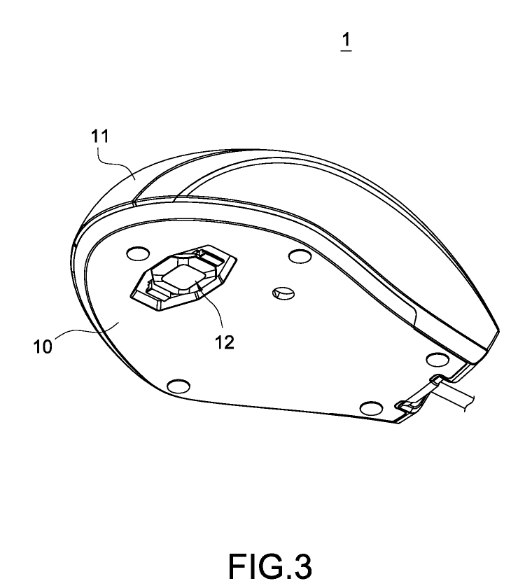

Please refer to FIGS. 1 to 3. FIG. 1 is an exploded perspective view showing the structure of a first embodiment of the present invention. FIG. 2 is an exploded perspective view showing the first embodiment of the present invention, in which a weight cartridge is removed from the mouse. FIG. 3 is an assembled perspective view showing the first embodiment of the present invention, in which the weight cartridge is disposed in the mouse. The present invention provides a mouse having an adjustable weight cartridge at its center of gravity. A casing 1 of the mouse is gripped by a user and located in the center of palm of the user. The casing 1 is provided with a removable weight cartridge 12. The user may dispose any number of counterweight 13 (even zero) in the weight cartridge 12 based on his/her demands. In this way, the user can adjust the total weight of the mouse to generate a preferred operating feeling.

The casing 1 is used as a portion of the housing of the mouse and comprises a base 10 and an upper shroud 11. The casing 1 is gripped by the use. The casing 1 is provided with a receiving trough 100 for receiving the weight cartridge 12. The receiving trough 100 is provided in the interior of the casing 1. In the first embodiment of the present invention, the receiving trough 100 is provided within the casing 1 in a vertical orientation. The bottom surface of the base 10 of the casing 1 is provided with an opening through which the receiving trough 100 is disposed in the casing 1. The receiving trough 100 extends through the upper shroud 11 (as shown in the drawings) or not through the upper shroud 11.

The weight cartridge 12 allows at least one counterweight 13 to be disposed therein. Then, the combination of the weight cartridge 12 and the at least one counterweight 13 are disposed in the receiving trough 100 of the casing 1. Alternatively, the weight cartridge 12 may be disposed in the receiving trough 100 without any counterweight 13. The weight cartridge 12 has a carrier 120. Two spaced supporting arms 121 extend upright from the carrier 120. A plurality of partitioning plates 122 is arranged at intervals along the lengthwise direction of each supporting arm 121, so that the counterweight 13 can be disposed between two adjacent partitioning plates 122. The counterweight 13 may be disposed between the partitioning plates 122 from either side of the two supporting arms 121. The more the counterweights 13 are disposed in the weight cartridge 12, the larger the total weight of the weight cartridge 12 is. Thus, the number of the counterweights 13 can be freely selected and adjusted by the user based on his/her demands.

The counterweight 13 may be a balance weight and disposed between two adjacent partitioning plates 122 of the weight cartridge 12. The counterweights 13 may have equal or different size or weight, so that the user can generate a preferred weight of the mouse based on his/her demands.

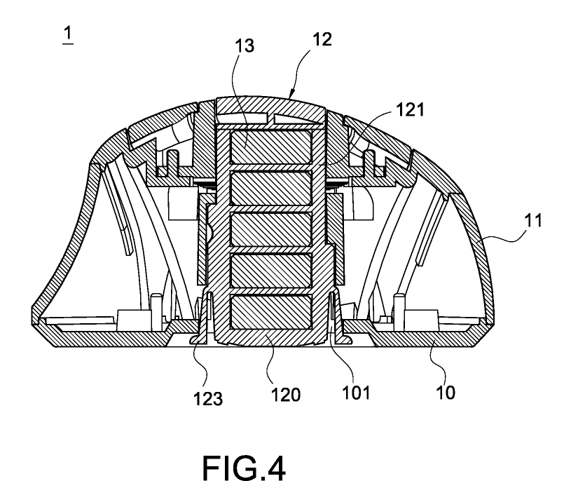

Please also refer to FIG. 4. In the weight cartridge 12, the outer edge of the carrier 120 is provided with a plurality of elastic hooks 123. The receiving trough 100 is provided with engaging holes 101 at positions corresponding to the elastic hooks 123. After the weight cartridge 12 is disposed in the receiving trough 100, the elastic hooks 123 are engaged in the engaging holes 101, thereby fixing the weight cartridge 12 into the receiving trough 100. When the user intends to detach the weight cartridge 12 from the receiving trough 100, the user only needs to press the elastic hooks 123 to remove the elastic hooks 123 from the engaging holes 101.

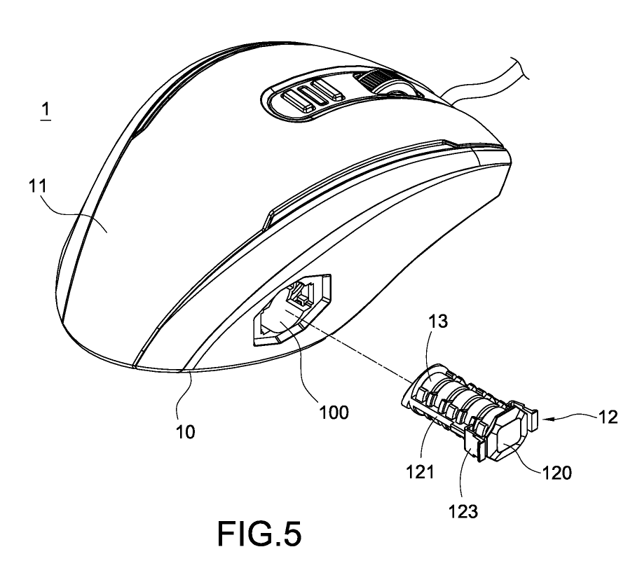

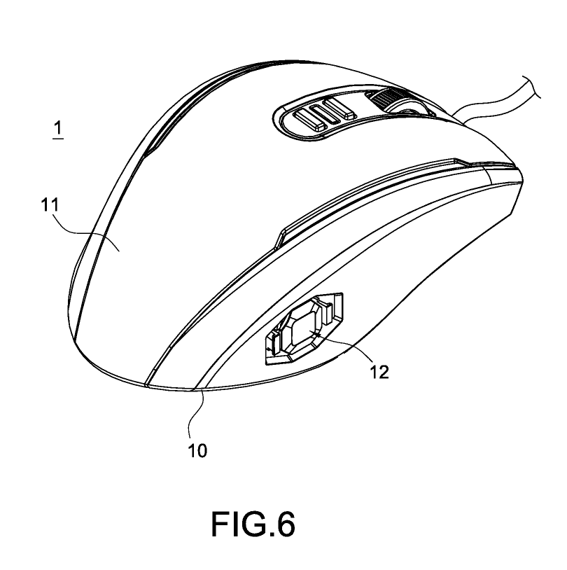

Further, as shown in FIGS. 5 and 6, in the second embodiment of the present invention, the receiving trough 100 is provided within the casing 1 in a transverse orientation. One side of the upper shroud 11 of the casing 1 is provided with an opening through which the weight cartridge 12 is disposed in the receiving trough 100. Also, the receiving trough 100 is provided in the casing 1 at a position which can be still gripped by the user.

With the above structure, the mouse having an adjustable weight cartridge at its center of gravity according to the present invention can be obtained.

Therefore, according to the present invention, the user can adjust the number of the counterweights 13 to generate a preferred total weight of the mouse 1 and in turn a preferred operating feeling. Since the partitioning plates 122 of the weight cartridge 12 are arranged in the lengthwise direction of the two supporting arms 121, the counterweight 13 may be disposed in a vertical or horizontal stack. As a result, the total weight of the counterweights 13 is concentrated without distributing in a plane. As a result, after the weight cartridge 12 and the counterweights 13 are disposed in the receiving trough 100 at a position of the casing 1 gripped by the user and located in the center of gravity, a better effect of weight concentration can be generated.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A mouse having an adjustable weight cartridge at its center of gravity, configured to generate a desired total weight by using at least one counterweight and including:
a casing gripped by a user and located in a center of palm of the user, an interior of the casing being provided with a receiving trough; and
a weight cartridge removably disposed in the receiving trough of the casing, the at least one counterweight being disposed in the weight cartridge in a stack.

2. The mouse having an adjustable weight cartridge at its center of gravity according to claim 1, wherein the weight cartridge has a carrier, two spaced supporting arms extend upright from the carrier, a plurality of partitioning plates is arranged at intervals between the two supporting arms in a lengthwise direction of the supporting arms, and the at least one counterweight is disposed between two adjacent partitioning plates.

3. The mouse having an adjustable weight cartridge at its center of gravity according to claim 2, wherein an outer edge of the carrier of the weight cartridge is provided with a plurality of elastic hooks, the receiving trough is provided with engaging holes corresponding to the elastic hooks.

4. The mouse having an adjustable weight cartridge at its center of gravity according to claim 1, wherein the casing comprises a base and an upper shroud, the receiving trough is provided upright in the casing, and a bottom of the base is provided with an opening through which the weight cartridge is disposed in the casing.

5. The mouse having an adjustable weight cartridge at its center of gravity according to claim 4, wherein the receiving trough further extends through the upper shroud of the casing.

6. The mouse having an adjustable weight cartridge at its center of gravity according to claim 1, wherein the casing comprises a base and an upper shroud, the receiving trough is provided transversely in the casing, and one side of the upper shroud is provided with an opening through which the weight cartridge is disposed in the casing.

7. A mouse having an adjustable weight cartridge at its center of gravity, including:
a casing gripped by a user and located in a center of palm of the user, an interior of the casing being provided with a receiving trough;
a weight cartridge removably disposed in the receiving trough of the casing; and
at least one counterweight disposed in the weight cartridge in a stack.

8. The mouse having an adjustable weight cartridge at its center of gravity according to claim 7, wherein the weight cartridge has a carrier, two spaced supporting arms extend upright from the carrier, a plurality of partitioning plates is arranged at intervals between the two supporting arms in a lengthwise direction of the supporting arms, and the at least one counterweight is disposed between two adjacent partitioning plates.

9. The mouse having an adjustable weight cartridge at its center of gravity according to claim 8, wherein an outer edge of the carrier of the weight cartridge is provided with a plurality of elastic hooks, and the receiving trough is provided with engaging holes corresponding to the elastic hooks.

10. The mouse having an adjustable weight cartridge at its center of gravity according to claim 7, wherein the casing comprises a base and an upper shroud, the receiving trough is provided upright in the casing, and a bottom of the base is provided with an opening through which the weight cartridge is disposed in the casing.

11. The mouse having an adjustable weight cartridge at its center of gravity according to claim 10, wherein the receiving trough further extends through the upper shroud of the casing.

12. The mouse having an adjustable weight cartridge at its center of gravity according to claim 7, wherein the casing comprises a base and an upper shroud, the receiving trough is provided transversely in the casing, and one side of the upper shroud is provided with an opening through which the weight cartridge is disposed in the casing.

13. The mouse having an adjustable weight cartridge at its center of gravity according to claim 7, wherein each of the counterweight is a balance weight.
